(19) United States
(12) Patent Application Publication
(10) Pub. No.: US 2011/0143157 A1
(43) Pub. Date: Jun. 16, 2011

(54) WATER BORNE ADHESIVE COMPOSITION FOR DRY LAMINATION AND LAMINATE FABRICATED USING THE SAME

(75) Inventors: Myoung-Sik SHIM, Yongin-si (KR); Takayasu HIRANO, Chiba-city (JP)

(73) Assignee: Advanced Polymer Emulsions Company, Ltd., Ansan-si (KR)

(21) Appl. No.: 12/964,884

(22) Filed: Dec. 10, 2010

(30) Foreign Application Priority Data
Dec. 10, 2009 (KR) 2009-0122712

(51) Int. Cl. B32B 27/10; C08K 5/521; B32B 27/30

(52) U.S. Cl. 428/514; 524/147; 428/522

(57) ABSTRACT

Disclosed are an aqueous adhesive composition for dry lamination and a laminate fabricated using the same. More particularly, the disclosed aqueous adhesive composition for dry lamination includes an aqueous resin dispersion A and a water-dispersible isocyanate B, wherein the aqueous resin dispersion A is prepared using the following ingredients (a) to (d), that is, an unsaturated monomer having a hydroxyl group (b), C1-C4 alkyl acrylic and/or methacrylic ester (c) and an additional unsaturated monomer (d) co-polymerizable with the unsaturated monomer (a), in the presence of an emulsifier having a phosphate group (a). The aqueous adhesive composition for dry lamination as described above exhibits excellent adhesion when used in laminate adhesion between at least two different plastic films, a plastic film and an aluminum foil or a metal welding film, etc., while having superior hydrothermal resistance sufficient for a resulting laminate to endure hot water conditions. This adhesive composition is a non-solvent adhesive and does not adversely influence the environment, while having excellent performance comparable to solvent type polyurethane. Moreover, the inventive composition has economic advantages.

### CROSS REFERENCE TO RELATED APPLICATIONS

This application claims priority from Korean Patent Application No. 2009-0122712, filed on Dec. 10, 2009 in the Korean Intellectual Property Office, the entire disclosure of which is incorporated herein by reference.

### BACKGROUND OF THE INVENTION

1. Field of the Invention

The present invention relates to a water borne adhesive composition for dry lamination, and more particularly, to a water borne adhesive composition for dry lamination, which exhibits excellent adhesion when used to adhere at least two plastic films, a plastic film with an aluminum foil, or a plastic film with a metalized film so as to form a laminate, and has superior hydrothermal resistance sufficient to allow the laminate to endure hot water conditions.

2. Description of the Related Art

Conventional adhesive compositions for dry lamination are generally used to prepare a solvent type adhesive based on polyurethane, which requires ethyl acetate as a principal solvent. Such a solvent type adhesive shows high adhesion ability. However, a solvent ingredient of the adhesive releases to the air during application thereof, thus causing adverse effects to the environment such as offensive odor, air pollution, and the like, and encountering problems in view of resource saving or preservation.

In order to solve the foregoing problems, a non-solvent polyurethane or an aqueous polyurethane have been recently developed. However, such non-solvent type adhesive requires an exclusive laminator to form a laminate therefrom, lacks hydrothermal resistance, and is relatively expensive. In addition, the water borne adhesive has insufficient adhesive performance. Meanwhile, since a metalized film currently comes into use in order to improve food preservation, improvement in adhesive ability between a plastic film and the metalized film is still required.

Among conventional technologies in relation to the present invention, Korean Patent Laid-Open No. 2005-80055, entitled “Eco-friendly aqueous adhesive and preparation thereof,” describes an aqueous adhesive which includes acrylic emulsion, stone powder, an adhesion aid (pine resin, acrylic adhesive), water, additives (a dispersing agent, a defoaming agent, a viscosity enhancer, a preservative, an emulsifier), a functional support (loess, anion, germanium, gemstone powder), nano-silver and tourmaline, and has eco-friendly features such as antibacterial effects, far-infrared radiation, anion radiation, etc., thereby being applicable to tiles and synthetic sheets. U.S. Pat. No. 4,442,258, entitled “Aqueous vacuum adhesive composition,” describes an aqueous ethylene unsaturated monomer composition (which is an aqueous vacuum adhesive containing a copolymer and additives such as acrylic acid, methacrylic acid, crotonic acid, and alcoholic plasticizer). Korean Patent No. 786,046, entitled “Water-dispersion type acrylic resin composition,” describes a water-dispersible acrylic resin composition (one-component stabilization) comprising acrylic monomer, an oxazoline compound and an amine compound, which is useful for a coating film with excellent water resistance and weatherproof properties. Japanese Patent Laid-Open No. 2007-290169, entitled “Adhesion method of a film for a soft package bag,” describes an adhesive film prepared by adding a film to a heat welding layer made of polyethylene (PE)/PET(EVOH)/nylon, and heating an outer side of the film to be welded. Korean Patent Laid-Open No. 2008-24561, entitled “Aqueous adhesive composition using a reactive surfactant for industrial application,” describes an aqueous adhesive composition including at least one monomer selected from BA, EHA and AA, as well as a surfactant, a buffer, a molecular weight regulator, an initiator and pure water, which is applicable to eco-friendly construction materials. However, conventional techniques in the foregoing documents are distinguishable from the present invention in terms of technical configuration.

### BRIEF SUMMARY OF THE INVENTION

The present invention is directed to a water borne adhesive composition for dry lamination and a laminated films using it, and the composition includes an aqueous resin dispersion A and a water-dispersible isocyanate B wherein the aqueous resin dispersion A comprises an unsaturated monomer (b) having a hydroxyl group, C1-C4 alkyl ester (c) such as acrylate, methacrylate, and an additional unsaturated monomer (d) co-polymerizable with the unsaturated monomer (b).

In consideration of the foregoing circumstances, an object of the present invention is to provide a water borne adhesive composition for dry lamination with advantageous features, including: water borne without environmental pollution; favorable performance comparable to solvent polyurethane to ensure excellent adhesion between at least two plastic films, a plastic film with an aluminum foil, and/or a plastic film with a metalized film; superior hydrothermal resistance; economic benefits, and so forth.

As a result of extensive discussions and studies, the present inventors found that the foregoing objects can be attained by a cross-linking composition comprising an aqueous acrylic resin dispersion prepared using a phosphate group containing emulsifier, wherein the dispersion has a certain amount of hydroxyl, carbonyl and carboxyl groups, as well as a water-dispersible isocyanate.

Based on the foregoing, the present invention has been completed and, briefly, provides an adhesive composition for dry lamination, including an aqueous resin dispersion A and a water-dispersible isocyanate derivative B which has at least two isocyanate groups in a molecule, wherein the aqueous resin dispersion A is prepared through emulsion-polymerization of: 0.1 to 10 wt % of acrylic and/or methacrylic ester (b) having a hydroxyl group; 60 to 95 wt. % of C1-C4 alkyl acrylic and/or methacrylic ester (c); and 0.9 to 30 wt. % of additional unsaturated monomer (d) co-polymerizable with the above unsaturated monomer, in the presence of an emulsifier (a) having a phosphate group.

According to the present invention, there is provided a water borne adhesive composition for dry lamination with beneficial features such as a non-solvent type adhesive with performance comparable to typical solvent polyurethane adhesives, and economic advantages. The inventive adhesive composition exhibits excellent adhesion when used in laminate adhesion between at least two different plastic films, a plastic film and an aluminum foil or a metalized film, etc., while having superior hydrothermal resistance sufficient for a resulting laminate to endure hot water conditions.

### DETAILED DESCRIPTION OF THE INVENTION

Hereinafter, preferred embodiments of the present invention will be described in more detail through the following examples.

A water borne adhesive composition for dry lamination of the present invention comprises an aqueous resin dispersion A and a water-dispersible isocyanate B. The aqueous resin dispersion A is prepared using the following ingredients (a) to (d), that is, an unsaturated monomer having a hydroxyl group (b), C1-C4 alkyl acrylic and/or methacrylic ester (c) and an additional unsaturated monomer (d) co-polymerizable with the unsaturated monomer (a), in the presence of an emulsifier having a phosphate group (a).

The emulsifier (a) may comprise, for example, a surfactant containing a phosphate group, such as polyoxyethylene alkyl ether phosphate, polyoxypropylene alkyl ether phosphate, etc.

The ingredient (a) may enhance adhesive strength after lamination of a metalized film to a plastic film. Preferably, the unsaturated monomer having a phosphate group is more effective. The ingredient (a) may enable stable preparation of the aqueous resin dispersion A to adjust the adhesive strength. An amount of the ingredient (a) used herein typically ranges from 0.1 to 5 wt. %, preferably 0.5 to 3 wt. % to a total weight of all unsaturated monomers used to prepare the aqueous resin dispersion A.

When a proportion of the ingredient (a) is less than 0.1 wt. %, this may not sufficiently function as described above. On the other hand, if a proportion of the ingredient (a) exceeds 5 wt. %, a hardness of an adhesive coating obtained using the ingredient (a) is too high to decrease shrinking stress, thus reducing adhesive strength after lamination. Additionally, other problems such as whitening of an adhesive layer in a laminate when immersed in hot water, little improvement in functions, etc., may be encountered.

The unsaturated monomer (b) is an unsaturated monomer having polymerizable double bonds, which contains at least one hydroxyl and carbonyl-based hydroxyl group (except a carboxyl group and a carbonyl group based on a carboxylic ester group) per molecule.

The ingredient (b) may include, for example: 2-hydroxyethyl acrylate; 2-hydroxylethyl methacrylate; 2-hydroxypropyl methacrylate; 2-hydroxybutyl acrylate; 2-hydroxybutyl methacrylate; glycidyl methacrylate; diacetone acrylamide; acetoacetoxyethyl methacrylate, etc.

Among these ingredient (b), diacetone acrylamide and 2-hydroxyethyl acrylate, 2-hydroxyethyl methacrylate are preferably used. The ingredient (b) may comprise a combination of two or more of these compounds.

The ingredient (c) is C1-C4 alkyl acrylic and/or methacrylic ester and may include, for example: lower alkyl acrylic ester such as methyl acrylate, ethyl acrylate, n-propyl acrylate, n-butyl acrylate, isobutyl acrylate, etc.; lower alkyl methacrylic ester such as methyl methacrylate, ethyl methacrylate, n-propyl methacrylate, n-butyl methacrylate, etc., and so forth. In order to facilitate strength control of an adhesive coating and improve co-polymerizable properties, methyl methacrylate and n-butyl acrylate are preferably used.

The ingredient (c) may express surface adhesion of the adhesive composition of the present invention and maintain flexibility of a laminate prepared using the ingredient (c). An amount of the ingredient (c) typically ranges from 60 to 95 wt. %, preferably 75 to 85 wt. %, in terms of a proportion of the ingredient (c) relative to all unsaturated monomers used to prepare the aqueous resin dispersion A. When a proportion of the ingredient (c) is less than 60 wt. %, this may not sufficiently function as described above. On the other hand, if a proportion of the ingredient (c) exceeds 95 wt. %, the inventive adhesive composition has decreased shear stress of a coating layer, thus reducing adhesive strength after lamination.

The ingredient (d) is an additional unsaturated monomer co-polymerizable with the unsaturated monomer (b) and may include, for example: an unsaturated monomer having an amide group such as hexyl acrylate, 2-ethylhexyl acrylate, -octyl acrylate, nonyl acrylate, decyl acrylate, lauryl acrylate, stearyl acrylate, styrene, α-methyl styrene, acrylonitrile, methacrylonitrile, vinyl acetate, vinyl propionate, ethylene, acrylamide, methacrylamide, N-methylol acrylamide, etc.; an unsaturated monomer having a carboxyl group such as acrylic acid, methacrylic acid, itaconic acid, maleic acid, etc.

When the aqueous adhesive composition for dry lamination comprises a water-dispersible isocyanate according to preferred embodiments of the present invention described below, the ingredient (b) may be an unsaturated monomer to crosslink a compound having an isocyanate group, including, for example, 2-hydroxyethyl acrylate, 2-hydroxyethyl methacrylate, 2-hydroxypropyl methacrylate, 2-hyroxybutyl acrylate, 2-hydroxybutyl methacrylate, glycidyl methacrylate, diacetone acrylate, acetocetoxyethyl methacrylate, and the like.

For preparation of the aqueous resin dispersion A, in order to increase adhesive strength after lamination, thus improving resistance to mechanical stress of the dispersion, and to enhance physical properties of a coating when a crosslinking agent is used, the ingredient (d) may contain the unsaturated monomer having a carboxyl group as described above, at least in a proportion of 0.2 to 6 wt. %, preferably 0.5 to 4 wt. % to all unsaturated monomers used to prepare the aqueous resin dispersion A. When an amount of the carboxyl group containing unsaturated monomer is less than 0.2 wt. %, the foregoing functions may not be sufficiently improved. On the other hand, if an amount of the carboxyl group containing unsaturated monomer exceeds 6 wt. %, certain problems such as whitening of an adhesive layer in a laminate when immersed in hot water may be encountered.

Emulsion polymerization may be effected by general methods to produce the aqueous resin dispersion A. More particularly, a monomer mixture comprising the foregoing ingredients (a) to (d) may be added to water containing a chain transfer agent, a dispersing agent, an emulsifier, protective colloids, etc. at a temperature of 70 to 95° C., for example, in the presence of a polymerization initiator, to conduct emulsion polymerization. These monomers may be introduced at the same time, continuously dropped in order, or added after forming an aqueous emulsion of these monomers.

The chain transfer agent used herein may be at least one or two selected from thioglycolate derivatives, mercapto compounds and β-mecapto propionate derivatives. An amount of the chain transfer agent may range from 0.1 to 5 wt. % of a total weight of the monomer mixture.

The emulsifier (a) may further include, for example: an anionic surfactant such as higher alcohol sulfate ester, alkylbenzene sulfonate, polyoxyethylene alkyl sulfate, polyoxyethylene alkylphenolether sulfate; or various non-ionic surfactants, which may be used in combination with polyoxyethylene alkyl ether phosphate and/or polyoxypropylene alkyl ether phosphate. Furthermore, a reactive emulsifier having a polymerizable double bond in a molecule may be used. An amount of the emulsifier may range from 0.1 to 5 wt. % of a total weight of all unsaturated monomers.

The protective colloid may be a copolymer comprising 0 to 50% of a monomer unit having at least one carbonyl group in a molecule or a monomer unit having at least one hydroxyl group in a molecule.

When using such copolymer-based protective colloid, this may be integrated with a resin molecule through crosslinking, and therefore, enhance adhesion and/or hydrothermal resistance of an adhesive layer formed using the adhesive composition of the present invention.

The polymerization initiator may include, for example: persulfates such as potassium persulfate, sodium persulfate, ammonium persulfate, etc.; peroxide catalysts such as benzyl peroxide, di-t-butyl peroxide, etc.; azo catalysts such as azo-bis isobutyronitrile, azo-bis isobutyric acid nitrile, and so forth. Furthermore, Redox initiator using a reductive agent may also be used.

The adhesive composition containing the aqueous resin dispersion A according to the present invention, which is an aqueous adhesive composition for dry lamination, may exhibit remarkably enhanced adhesion. Where this composition is used for hydrothermal treatment of a laminate, at least one or two selected from polyoxazoline compounds and carboxylmide compounds as well as the water-dispersible isocyanate compound B, may be preferably added to the resin dispersion A, so as to improve hydrothermal resistance. If high hydrothermal resistance is not required, a desired hydrazine compound may be selected and used as a single-component hardening laminate adhesive. Such hydrazine compound may include, for example, adipic hydrazide, carbo dihydrazide, carbon dihydrazide, sebacic dihydrazide, etc.

The water-dispersible isocyanate compound is not particularly limited but generally includes isocyanate compounds containing hydrophilic groups derived from non-ionic groups (for example, polyoxyalkylene group) or anionic groups (for example, carbonic acid, sulfonic acid or phosphonic acid). In addition, the number of functional groups in the isocyanate group may be two, three or more. Such isocyanate compounds may include, for example, a reaction product of an excess polylsocyanate compound with a polyol compound, a reaction product of a polyisocyanate compound with a polyamine compound, hydrogen in urethane bonds, an allophanate compound obtained by reaction of hydrogen in urethane bonds with isocyanate groups, and so forth. Particular examples thereof may be commercially available products under trade name ‘BAYHYDUR 3100’ purchased from Beyer and ‘BASONATFDS 3425’ purchased from BASF.

The polyoxazoline compound generally has at least two oxazoline rings in a molecule and may be compatible with the ingredient A. Particular examples of such polyoxazoline compound may be ‘Epocross K-2010 E’, Tpocross K-2020 E′ (trade names, manufactured by Nippon Shokubai Co., Ltd.), etc.

The carbodiimide based compound may include, for example, ‘Carbodilite E-02’, ‘Carbodilite V-04’, Carbodilite E-01′, ‘Carbodilite E-02’ (trade names, manufactured by NISSHINBO), etc.

An amount of the ingredient B used herein generally ranges from 0.5 to 10 wt. parts to 100 wt. parts of the ingredient A in terms of solid content.

The adhesive composition of the present invention may further contain other resin components in a certain range of amount by which physical properties of the composition are not adversely influenced. Such resin components may include, for example: a water-soluble resin such as cellulose resin, acrylic resin, polyester resin, etc.; an alkali-soluble resin; and an aqueous resin dispersion containing an acrylic resin emulsion or urethane resin emulsion. The adhesive composition of the present invention may also contain various additives such as a dispersing agent, a defoaming agent, a viscosity enhancer, a wetting agent, a solvent, a plasticizer, an anti-freezing agent, etc. in order to regulate or control coating effects or storage of the composition.

The aqueous resin dispersion A according to the present invention is usually subjected to neutralization using a neutralizer after it was prepared through emulsion polymerization. Such a neutralizer may comprise volatile alkaline compounds such as ammonia, triethylamine, etc. When food is packaged in a laminate container, the volatile alkaline compound may be transferred to content of the container and create bad smell, thus being not preferable. Therefore, an inorganic alkaline compound or non-volatile amine is preferably used as the neutralizer. Such inorganic alkaline compounds may include, for example, sodium hydroxide, potassium hydroxide, etc., while the non-volatile amine may be diethanolamine, triethanolamine, diethylene triamine, etc.

Other than ammonia used as a neutralizer, the aqueous resin composition A of the present invention may further contain other ammonia components derived from an anionic surfactant which is used for emulsion polymerization, an initiator such as ammonium persulfate, and the like. Depending on use of the adhesive composition of the present invention, the foregoing conditions should be considered in designing emulsion polymerization.

The water borne adhesive composition for dry lamination according to the present invention may further include a crosslinking agent comprising at least one or two compound(s) selected from carbodiimide compounds, polyoxazoline compounds and hydrazine compounds, as a crosslinking component.

More particularly, the water borne adhesive composition for dry lamination according to the present invention may contain 0.1 to 1.0 wt. % of a crosslinking agent comprising at least one or two compound(s) selected from carbodiimide compounds, polyoxazoline compounds and hydrazine compounds, as a crosslinking component.

The present invention also provides a laminate fabricated by laminating at least two plastic films with application of the water borne adhesive composition for dry lamination of the present invention.

The present invention further provides a laminate fabricated by laminating at least two paper sheets with application of the water borne adhesive composition for dry lamination of the present invention.

### EXAMPLES

The following description will be given of examples and comparative examples of the present invention to more concretely describe preferred embodiments of the present invention, however, such embodiments are provided for illustrative purposes but are not construed to restrict the scope of the present invention. In the following description, “part” and “%” denote part by weight (wt. part) and % by weight (wt. %), respectively. Assessment was performed by the following procedures, that is; an aqueous adhesive composition for dry lamination was prepared in each of the examples and comparative examples, a film laminate was formed using this adhesive composition by the following processes, and then, the fabricated film laminate was subjected to a strength test of a dry laminate and a water boiling test, respectively. Test results are shown in TABLE 1.

(1) Preparation of a film laminate: After dissolving a water borne adhesive composition for dry lamination in water to prepare a solution having a solid content of 30%, the solution was applied to an oriented polypropylene film (hereinafter, referred to as ‘OPP film’) and a nylon film (hereinafter, referred to as ‘Ny film’) by means of a bar coater (manufactured by KIBE), in a coating amount of adhesive of 3 g/m2 (in terms of solid content). Following this, each of the coated films was dried under the following conditions. A non-oriented polypropylene film (hereinafter, referred to as ‘CPP film’) and an aluminum deposited non-oriented polypropylene film (hereinafter, referred to as ‘VM-CPP film’) were attached to each of the obtained OPP film and the Ny film at a line speed of 100 mm/min and a pressure of 1.6 kg/cm2 followed by leaving the treated film at 50° C. for 12 hours to cure the same, thereby forming a film laminate. Details of respective films used therein are described below.

### Film

OPP film with a thickness of 20 μm: product of SAM YOUNG CHEMICAL Co. Ltd., CPP film with a thickness of 20 μm: product of SAM MIN CHEMICAL Co. Ltd.

(2) Strength test of a dry laminate: After cutting the fabricated film laminate as described above into a specimen having a size of width 15 mm×length 150 mm, release strength when laminate films at both sides of the specimen are T-shape released by means of a tensile tester (manufactured by Shimadzu Corp.) at a certain head speed/min, was measured and the measured numeral value (N/15 mm) was recorded.

(3) Water boiling test (WBT): After preparing an envelop type Ny film/CPP film laminate, the envelop type laminated was filled with water then sealed. This laminate was impregnated with hot water at 98° C. for 60 minutes and WBT suitability assessment was performed by observing the appearance of the impregnated laminate. The assessment was carried out in the following three stages and Results thereof are denoted as A, B and C.

A: Variation in appearance is not observed.

B: Laminate adhesion defects in a stem or pin-hole shape is observed.

C: Adhesion defects are observed throughout the laminate.

### Example 1

A mixture including: 40 wt. parts of butyl acrylate as a radical polymerizable monomer; 40 wt. parts of ethyl acrylate; 12 wt. parts of methyl methacrylate; 2 wt. parts of acrylic acid; 5 wt. parts of 2-hydroxyethyl methacrylate; 5 wt. part of diacetone acrylamide; and 1 wt. part of n-dodecyl mercaptane, was prepared. 2 wt. parts of polyoxyethylene alkyl ether phosphate and 50 wt. parts of desalted water were added to the prepared mixture under stirring using a homo-mixer, and a monomer containing composition emulsion was introduced into a drop-in bath.

To a polymerization reactor equipped with a heater, an agitator, a reflux condenser, a thermometer, an N2 feeding pipe and a drop-in bath, 49 wt. parts of the desalted water was entered and stirred under an N2 atmosphere, followed by increasing an internal temperature to 78° C. 3% potassium persulfate solution with a solid content of 0.1 wt. parts was added to the reactor. After 5 minutes, the monomer containing composition emulsion and 3% potassium persulfate solution with a solid content of 0.35 wt. parts from separate drop-in baths were dropped into the reactor and polymerization was effected therein. The reactor was maintained at 80° C. for 30 minutes after completion of the dropping, followed by adding 0.1 wt. parts of t-butyl hydroperoxide and 0.12 wt. parts of Bruggolite FF6 to the reactor three times at a constant interval of 10 minutes and at an internal temperature of 60° C. for 30 minutes. After the mixture in the reactor was again subjected to polymerization for 1 hour under stirring, the reaction product was neutralized using an ammonia water and filtered through a nylon filter cloth in 200 mesh, thereby producing an acrylic polymer-containing composition emulsion with non-volatile content of 45.3% and viscosity of 20 mPa·s.

Next, 0.1 wt. parts of a defoaming agent (containing 50 wt. % of water-soluble components) and 1 wt. part of water-soluble sodium dioctyl sulfoxinate as a wetting agent were added to 100 wt. parts of the obtained acrylic polymer-containing composition emulsion and 5 wt. parts of a water-dispersible isocyanate was further added to the mixture, thus obtaining an aqueous adhesive composition for dry lamination.

### Examples 2 to 5

As shown in TABLE 1, the same procedures as described in Example 1 were conducted except that the monomer containing composition emulsion was adjusted. As a result, an acrylic polymer-containing composition emulsion with non-volatile content of 45.1% and viscosity of 25 mPa·s was prepared. The same additives as described in Example 1, that is, the defoaming agent, the wetting agent, the viscosity enhancer and the water-dispersible isocyanate were added to the prepared emulsion, thereby obtaining an aqueous adhesive composition for dry lamination. All experimental processes were the same as described in Example 1.

### Comparative Examples 1 to 3

As shown in TABLE 1, the same procedures as described in Example 1 were conducted except that the monomer containing composition emulsion was adjusted.

TABLE 1

| | | | | | | | Com | Com | Com |
|---|---|---|---|---|---|---|---|---|---|
| Section | | Ex. 1 | Ex. 2 | Ex. 3 | Ex. 4 | Ex. 5 | Ex. 1 | Ex. 2 | Ex. 3 |
| MMA | M1 | 12 | 12 | 12 | 12 | 12 | 12 | 12 | 12 |
| St | M2 | 0 | 0 | 0 | 0 | 20 | 0 | 0 | 0 |
| nBMA | M3 | 0 | 0 | 0 | 20 | 0 | 0 | 0 | 0 |
| EA | M4 | 40 | 40 | 40 | 0 | 20 | 40 | 40 | 40 |
| BA | M5 | 40 | 40 | 20 | 40 | 40 | 40 | 40 | 40 |
| 2EHA | M6 | 0 | 0 | 20 | 0 | 0 | 0 | 0 | 0 |
| AA | M7 | 2 | 2 | 2 | 4 | 4 | 2 | 2 | 1 |
| 2HEMA | M8 | 5 | 5 | 5 | 3 | 3 | 5 | 5 | 5 |
| DAAM | M9 | 1 | 1 | 0 | 1 | 1 | 1 | 1 | 1 |
| AAEM | M10 | 0 | 0 | 1 | 0 | 0 | 0 | 0 | 0 |
| MEP | M11 | 0 | 0 | 0 | 0 | 0 | 0 | 0 | 1 |
| Emulsifier | (2% vs. M) | S1 | S2 | S1/S3 | S2/S3 | S1 | S3 | S4 | S3 |
| Crosslining | (5% vs. EM) | C1 | C1 | C1 | C2 | C3 | C1 | C1 | C1 |
| agent | | | | | | | | | |
| OPP/VM-CPP | Adhesion | 4.4 | 4.8 | 4.0 | 3.3 | 2.9 | 0.6 | 0.5 | 0.8 |
| | (N/15 mm) | | | | | | | | |
| Ny/OPP | Hydrothermal | A | A | A | A-B | A-B | C | C | C-B |
| | resistance | | | | | | | | |

M: Monomer,
EM: Emulsion
M1: Methyl methacrylate
M2: Styrene
M3: n-butyl methacrylate
M4: Ethyl acrylate
M5: n-butyl acrylate
M6: 2-ethylhexyl acrylate
M7: Acrylic acid
M8: 2-hydroxy methacrylate
M9: Diacetone acrylamide
M10: Acetoacetoxy ethyl methacrylate
M11: 2-Methacryloxy ethyl phosphate
S1: Polyoxyethylene alkyl ether phosphate
S2: Polyoxypropylene alkyl ether phosphate
S3: Polyoxyethylene alkyl sulfate
S4: Alkylbenzene sulfonate
C1: Water-dispersible isocyanate (product of BEYER, trade name, ‘BAYHYDUR 3100’)
C2: Polyoxazoline compound (product of Nippon Shokubai, trade name, ‘Epocross K-2020 E’)
C3: Carbodiimide compound (product of NISSHINBO, trade name, ‘Carbodilite E-02’)

As described above, the adhesive composition of the present invention exhibits excellent adhesion when used to adhere at least two plastic films, a plastic film with an aluminum foil, or a plastic film with a metal welding film so as to form a laminate, and has superior hydrothermal resistance sufficient to allow the laminate to endure hot water conditions. Additionally, the adhesive composition of the present invention is a non-solvent adhesive and does not adversely influence the environment, while having excellent performance comparable to solvent type polyurethane. Moreover, the inventive composition has economic benefits, thus being widely employed in various industrial applications.

1. A water borne adhesive composition for dry lamination, including an aqueous resin dispersion A and a water-dispersible isocyanate derivative B which has at least two isocyanate groups in a molecule, wherein the aqueous resin dispersion A is prepared through emulsion-polymerization of:
0.1 to 10 wt % of acrylic and/or methacrylic ester (b) having a hydroxyl group;
60 to 95 wt. % of C1-C4 alkyl acrylic and/or methacrylic ester (c); and
0.9 to 30 wt. % of additional unsaturated monomer (d) co-polymerizable with the above unsaturated monomer, in the presence of an emulsifier (a) having a phosphate group.

2. The water borne adhesive composition according to claim 1, wherein an amount of the phosphate group-containing emulsifier ranges from 0.1 to 5 wt. % to the entire monomer mixture.

3. The aqueous adhesive composition according to claim 1, wherein the additional unsaturated monomer (d) contains at least one or two different monomers selected from a series of unsaturated monomers having carboxyl and carbonyl groups, in at least an amount of 0.1 to 10 wt. % to the entire monomer mixture.

4. The aqueous adhesive composition according to claim 1, further comprising a crosslinking agent including at least one or two compound(s) selected from carbodiimide compounds, polyoxazoline compounds and hydrazine compounds, as a crosslinking component.

5. A laminate fabricated by laminating at least two plastic films or paper sheets with application of the aqueous adhesive composition according to claim 1.
